(19) United States
(12) Patent Application Publication
(10) Pub. No.: US 2025/0167590 A1
(43) Pub. Date: May 22, 2025

(54) HYBRID ENERGY HARVESTING APPARATUS FOR HARVESTING OMNIDIRECTIONAL MULTI-BAND RADIO FREQUENCY ENERGY AND THERMOELECTRIC ENERGY

(71) Applicant: BEIJING INSTITUTE OF TECHNOLOGY, Beijing (CN)

(72) Inventors: Hailing FU, Beijing (CN); Zhuowen LIU, Beijing (CN); Fang DENG, Beijing (CN); Haopeng XIE, Beijing (CN); Ziyu WANG, Beijing (CN); Xiangyang WANG, Beijing (CN); Ning DING, Beijing (CN); Maobin LV, Beijing (CN); Jiadong ZHOU, Beijing (CN)

(73) Assignee: BEIJING INSTITUTE OF TECHNOLOGY, Beijing (CN)

(21) Appl. No.: 18/932,663

(22) Filed: Oct. 31, 2024

(30) Foreign Application Priority Data
Nov. 20, 2023 (CN) 202311548963.0

(51) Int. Cl. H02J 50/00; H02J 50/27; H02N 11/00

(52) U.S. Cl. CPC H02J 50/001; H02J 50/27; H02N 11/002

(57) ABSTRACT

A hybrid energy harvesting apparatus for harvesting omnidirectional multi-band radio frequency (RF) energy and thermoelectric energy includes a housing, an RF harvesting apparatus, a thermoelectric harvesting apparatus, and an energy storage apparatus. The housing is a hollow polyhedron. The thermoelectric harvesting apparatus includes a thermoelectric sheet applied to an outer side surface of the housing and a thermoelectric conditioning circuit mounted in the housing. The thermoelectric sheet is configured to harvest thermal energy and convert the thermal energy to electrical energy. The RF harvesting apparatus includes a multi-band two-dimensional antenna array tightly attached to the thermoelectric sheet and an RF-DC conditioning circuit mounted in the housing. A multi-band two-dimensional antenna in the multi-band two-dimensional antenna array is configured to harvest RF energy and convert the RF energy to electrical energy and dissipate heat from the thermoelectric sheet. The RF-DC conditioning circuit is connected to the multi-band two-dimensional antenna.

### CROSS REFERENCE TO THE RELATED APPLICATIONS

This application is based upon and claims priority to Chinese Patent Application No. 202311548963.0, filed on Nov. 20, 2023, the entire contents of which are incorporated herein by reference.

### TECHNICAL FIELD

The present disclosure relates to the technical field of energy harvesting, and specifically to a hybrid energy harvesting apparatus for harvesting omnidirectional multi-band radio frequency (RF) energy and thermoelectric energy.

### BACKGROUND

With the rapid development and popularization of Internet of Things and wireless sensing technologies, the demand of low-power smart devices has been increasing. In addition, conventional battery-powered methods have problems of short battery life, difficulty in battery replacement or charging, and battery waste in many application scenarios. To ensure reliability of long-term operation of devices, self-powered technologies have continuously being explored. Among others, RF energy harvesting technologies have been continuously developed.

RF energy and temperature difference energy widely exist in an environment, including radios, television signals, Wi-Fi signals, and heat generated by electronic devices, and the like. Energy harvesting technologies can make use of such energy in the environment by converting the energy to usable electrical energy, thereby achieving utilization and recycling of passive energy in the environment. In some specific application scenarios, devices such as those in a sensor network or for remote monitoring need to continuously operate for a long time without battery replacement or charging. The energy harvesting technologies can provide a continuous power supply by harvesting RF energy and temperature difference energy in the environment, to ensure stable operation of the devices for a long time.

However, existing RF harvesting systems have disadvantages of low utilization rate and low energy harvesting efficiency. A simple RF energy harvesting antenna was disclosed in a the prior art, where arc-shaped and circular antennas designed exhibit good and reliable reception performance for RF energy at frequencies of 2.55 GHZ, 3.5 GHZ, and 5.2 GHz, and can implement multi-band RF energy harvesting. However, the harvesting antenna can implement only unidirectional RF harvesting, and the overall harvesting efficiency of the apparatus is low.

The RF energy density in a natural space is relatively low, so multi-band, omnidirectional RF energy harvesting is of great importance to increasing the output power of an RF energy harvesting device. In addition, the combination of an antenna array structure of the RF energy harvesting system with a thermoelectric module is also an energy harvesting mode with wide application prospects, and is expected to play an important role in the future energy field.

### SUMMARY

The present disclosure provides a hybrid energy harvesting apparatus for harvesting omnidirectional multi-band RF energy and thermoelectric energy. The hybrid energy harvesting apparatus can omnidirectionally harvest RF energy of different frequencies, thermal energy in a natural environment, and thermal energy generated by a system, thereby saving the space while improving the energy harvesting efficiency.

The following technical solution is adopted in the present disclosure.

A hybrid energy harvesting apparatus for harvesting omnidirectional multi-band RF energy and thermoelectric energy is provided, including a housing, an RF harvesting apparatus, a thermoelectric harvesting apparatus, and an energy storage apparatus, where the housing is a hollow polyhedron;
the thermoelectric harvesting apparatus includes a thermoelectric sheet applied to an outer side surface of the housing and a thermoelectric conditioning circuit mounted in the housing;
a hot end of the thermoelectric sheet is connected to the housing and is configured to connect to a heat source, and a cold end of the thermoelectric sheet is located on a side of the thermoelectric sheet facing away from the housing; the thermoelectric sheet is configured to harvest thermal energy from an environment and the heat source and convert the thermal energy to electrical energy; the thermoelectric conditioning circuit is electrically connected to the thermoelectric sheet, and the thermoelectric conditioning circuit is configured to condition the electrical energy generated by the thermoelectric sheet;
the RF harvesting apparatus includes a multi-band two-dimensional antenna array tightly attached to the thermoelectric sheet and an RF-direct current (DC) conditioning circuit mounted in the housing; a multi-band two-dimensional antenna in the multi-band two-dimensional antenna array is configured to harvest the omnidirectional multi-band RF energy and convert the omnidirectional multi-band RF energy to electrical energy, and dissipate heat from the thermoelectric sheet; the RF-DC conditioning circuit is connected to the multi-band two-dimensional antenna, and the RF-DC conditioning circuit is configured to condition the electrical energy generated by the multi-band two-dimensional antenna; and
the energy storage apparatus is located in the housing, is electrically connected to the thermoelectric conditioning circuit and the RF-DC conditioning circuit, and is configured to store the electrical energy.

Further, the multi-band two-dimensional antenna is formed by a plurality of different cuboid sheets.

Further, the multi-band two-dimensional antenna is formed by three types of cuboid sheets with different lengths and widths.

Further, the hybrid energy harvesting apparatus further includes a circuit board arranged in the housing, where
the circuit board includes a rectification circuit, a filtering circuit, a conversion circuit, and a control chip; and
the thermoelectric conditioning circuit and the RF-DC conditioning circuit are both formed by the rectification circuit, the filtering circuit, and the conversion circuit.

Further, the hybrid energy harvesting apparatus further includes temperature sensors and current sensors mounted on the thermoelectric sheet and the multi-band two-dimensional antenna; and

the temperature sensors and the current sensors are in signal connection with the control chip.

Further, the housing is of a cubic structure, and the thermoelectric sheet is attached to a top surface and a side surface of the housing.

Further, the housing is made of an insulating material.

Further, the thermoelectric sheet is connected to the housing and the multi-band two-dimensional antenna by adhesion.

Further, the energy storage apparatus is a storage battery.

### Advantages:

1. The housing of the hybrid energy harvesting apparatus of the present disclosure is a hollow polyhedron. The thermoelectric sheet and the multi-band two-dimensional antenna array are stacked in sequence on the outer side surface of the housing. The thermoelectric conditioning circuit, the RF-DC conditioning circuit, and the energy storage apparatus are mounted in the housing. The thermoelectric sheet is sandwiched between the housing and the multi-band two-dimensional antenna. The cold end of the thermoelectric sheet is tightly attached to the multi-band two-dimensional antenna. The multi-band two-dimensional antenna harvests omnidirectional multi-band RF energy and convert the harvested RF energy to electrical energy. The RF-DC conditioning circuit conditions the electrical energy generated by the multi-band two-dimensional antenna. In addition, the multi-band two-dimensional antenna serves as a heat sink for the thermoelectric sheet, to cool down the cold end of the thermoelectric sheet to form a required temperature difference between the hot end and the cold end of the thermoelectric sheet. As such, the thermoelectric sheet fully captures thermal energy in the natural environment and the system, so that a voltage is generated on the surface of the thermoelectric material to form electrical energy, which is conditioned by the thermoelectric conditioning circuit. The energy storage apparatus stores the electrical energy that has been processed by the thermoelectric conditioning circuit and the RF-DC conditioning circuit, and provides the electrical energy to a load for use. Harvesting of omnidirectional multi-band RF energy and thermal energy is realized through the polyhedral housing, the thermoelectric sheet, and the multi-band two-dimensional antenna array. With the use of the multi-band technology, the hybrid energy harvesting apparatus can adapt to changes in the intensity and frequency of RF energy in different environments and working scenarios, and can capture more RF energy and convert the RF energy to electrical energy, thereby improving the energy harvesting efficiency.
2. The multi-band two-dimensional antenna array of the hybrid energy harvesting apparatus of the present disclosure realizes harvesting of omnidirectional multi-band RF energy. The proportion of RF energy in the space of a natural environment is low, and unidirectional RF harvesting cannot meet requirements on the energy harvesting efficiency of a self-powered apparatus in future Internet of Things applications. The hybrid energy harvesting apparatus uses a cubic housing, and the thermoelectric sheets and the multi-band two-dimensional antenna arrays are arranged on a top surface and a side surface of the cubic housing, i.e., the thermoelectric sheets and the multi-band two-dimensional antenna arrays are arranged on five sides of the housing. As such, a multi-directional RF energy harvesting technology is realized. Antennas in multiple directions enable the hybrid energy harvesting apparatus to harvest energy even in an environment with scarce RF energy, thereby achieving high adaptability and stability.
3. The thermoelectric sheet of the hybrid energy harvesting apparatus of the present disclosure has a characteristic of broadly harvesting thermal energy in a system. Because the thermoelectric sheet is tightly attached to the outer side surface of the housing, the thermoelectric sheet can capture thermal energy inside the housing to the greatest extent, to achieve efficient energy conversion. Therefore, the hybrid energy harvesting apparatus has excellent thermal energy harvesting performance, can adapt to various environmental conditions, and has high reliability and stability.
4. The hybrid energy harvesting apparatus of the present disclosure makes full use of the structural similarity between the antenna structure and a heat-dissipating metal plate, and the multi-band two-dimensional antenna array is tightly attached to the surface of the thermoelectric sheet, to realize conversion between RF energy and thermoelectric energy. By using such a structure, the energy harvesting efficiency can be significantly improved, and the spatial layout is optimized, thereby achieving miniaturization. The multi-band two-dimensional antenna array also serves as a heat-dissipating metal plate, and thermal energy generated by the hybrid energy harvesting apparatus and thermal energy in the surrounding environment are converted to electrical energy by the thermoelectric sheet, so that not only the energy conversion process is optimized, but also the conversion between the two types of energy is facilitated, thereby achieving higher energy harvesting efficiency. In addition, the multi-band two-dimensional antenna also serves as a heat dissipation structure for the thermoelectric sheet, thereby saving space, facilitating miniaturization, and providing new ideas and possibilities for further development and application of hybrid energy harvesting systems for harvesting RF energy and thermoelectric energy.
5. The hybrid energy harvesting apparatus of the present disclosure is of a compact design and a skillful structure, is convenient to operate and implement, has a wide application range, is applicable to various environments and scenarios, and exhibits excellent energy harvesting efficiency both indoors and outdoors. The hybrid energy harvesting apparatus may be used as a power supply device for nodes in a future environment of Internet of Things, to provide a stable energy supply to various devices, showing broad application prospects and huge development potential.

### BRIEF DESCRIPTION OF THE DRAWINGS

FIG. 1 is an overall schematic structural diagram of a hybrid energy harvesting apparatus for harvesting RF energy and thermoelectric energy according to the present disclosure.

FIG. 2 is a schematic structural exploded view of the hybrid energy harvesting apparatus for harvesting RF energy and thermoelectric energy in FIG. 1.

FIG. 3 is a schematic structural side view of the hybrid energy harvesting apparatus for harvesting RF energy and thermoelectric energy in FIG. 1.

In the drawings: 1-housing, 2-thermoelectric sheet, 3-two-dimensional antenna, 4-energy storage apparatus, 5-heat source, 6-circuit board

### DETAILED DESCRIPTION OF THE EMBODIMENTS

The technical solutions in the embodiments of the present invention will be described clearly and fully with reference to the accompanying drawings in the embodiments of the present invention. Apparently, the embodiments described are merely some embodiments, rather than all of the embodiments of the present invention. All other embodiments obtained by those of ordinary skill in the art without creative efforts based on the embodiments of the present invention shall fall within the protection scope of the present invention.

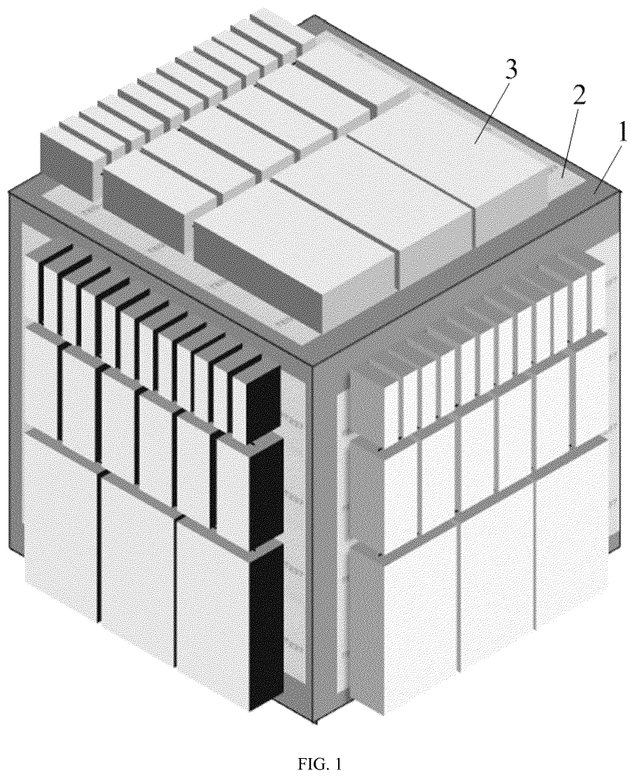

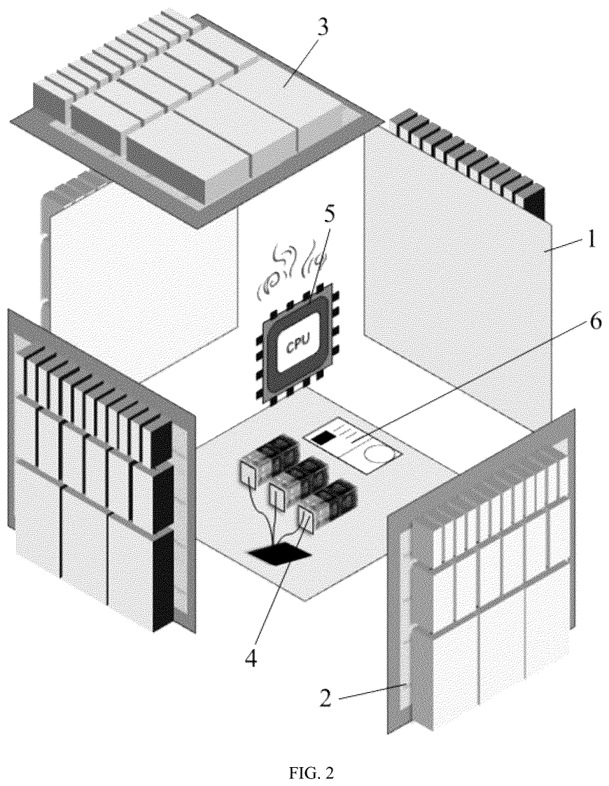

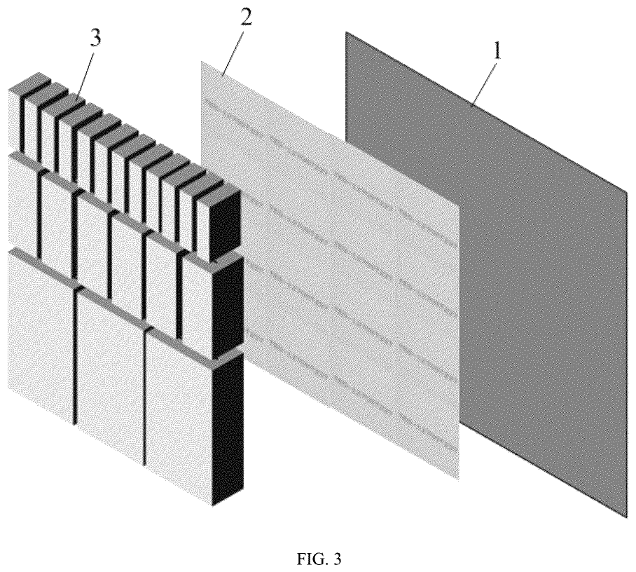

As shown in FIG. 1, FIG. 2, and FIG. 3, an embodiment provides a hybrid energy harvesting apparatus for harvesting omnidirectional multi-band RF energy and thermoelectric energy. The hybrid energy harvesting apparatus includes a housing 1, an RF harvesting apparatus, a thermoelectric harvesting apparatus, and an energy storage apparatus 4.

The housing 1 is a hollow polyhedron. A thermoelectric sheet 2 of the thermoelectric harvesting apparatus is attached on an outer side surface of the housing 1. As shown in FIG. 1, the housing 1 may be a hexahedron of a cubic structure. In this embodiment, the housing 1 of the cubic structure is used as an example for description. In practice, the housing 1 may be in other shapes. The thermoelectric sheet 2 is attached to a top surface and side surfaces of the housing 1. A bottom surface of the housing 1 is configured for supporting, and is supported by a ground or other base or platform. Identical structures are provided on five surfaces of the housing 1 other than the bottom surface, i.e., a multi-band two-dimensional antenna 3, the thermoelectric sheet 2, and the housing 1 are arranged in sequence on each of the five surfaces from outside to inside. The thermoelectric sheet 2 may be connected to the housing 1 by adhesion. The housing 1 is made of an insulating material to avoid short-circuit due to electrical conduction.

The thermoelectric harvesting apparatus includes the thermoelectric sheet 2 applied to the outer side surface of the housing 1 and a thermoelectric conditioning circuit mounted in the housing 1. A hot end of the thermoelectric sheet 2 is connected to the housing 1 and is configured to connect to a heat source 5, and a cold end of the thermoelectric sheet 2 is located on a side of the thermoelectric sheet 2 facing away from the housing 1. In other words, the hot end of the thermoelectric sheet 2 faces the housing 1, and the cold end of the thermoelectric sheet 2 faces the multi-band two-dimensional antenna 3. The thermoelectric sheet 2 is configured to harvest thermal energy from an environment and the heat source 5 and convert the thermal energy to electrical energy. The hot end of the thermoelectric sheet 2 is connected to the heat source 5 in an application scenario, for example, a central processing unit (CPU), a graphics card, a main board of a computer, or a heat generating part of an engine. The heat source 5 creates a temperature difference required by the thermoelectric sheet 2 to fully capture thermal energy in a natural environment and a system, which is converted to electrical energy and stored in the energy storage apparatus 4 or supplied to an electrical device. A plurality of thermoelectric sheets 2 form the thermoelectric harvesting apparatus. The thermoelectric conditioning circuit is electrically connected to the thermoelectric sheets 2 and is configured to condition the electrical energy generated by the thermoelectric sheets 2. The thermoelectric conditioning circuit is configured to rectify, filter, convert, or otherwise process a current generated by the thermoelectric sheets 2.

The RF harvesting apparatus includes multi-band two-dimensional antenna arrays tightly attached to the thermoelectric sheets 2 and an RF-DC conditioning circuit (not shown) mounted in the housing 1. The multi-band two-dimensional antenna arrays are each formed by a plurality of two-dimensional antennas 3 of different bands distributed in an array. The multi-band two-dimensional antenna 3 may be formed by a plurality of different cuboid sheets. In this embodiment, as shown in FIG. 1 and FIG. 2, the multi-band two-dimensional antenna 3 is formed by three different types of cuboid sheets. Each type of cuboid sheet has a different length and a different width. The plurality of two-dimensional antennas 3 constituting the multi-band two-dimensional antenna array are configured to harvest omnidirectional multi-band RF energy and convert the harvested RF energy to electrical energy, and dissipate heat from the thermoelectric sheets 2. The multi-band two-dimensional antennas 3 are made of a material with good thermal conductivity, such as an aluminum alloy, copper, etc. Because the two-dimensional antennas 3 have good thermal conductivity and heat dissipation performance, the two-dimensional antennas 3 are directly used as a heat sink for the thermoelectric harvesting apparatus to dissipate heat accumulated in the thermoelectric sheets 2, to ensure that the temperature of the cold ends of the thermoelectric sheets 2 is maintained at a low level. Therefore, the multi-band two-dimensional antennas 3 can be used to replace heat-dissipating metal plates, to improve the degree of system integration.

The RF-DC conditioning circuit is connected to the multi-band two-dimensional antennas 3, and is configured to condition the electrical energy generated by the multi-band two-dimensional antennas 3. The thermoelectric sheets 2 are connected to the housing 1 and the two-dimensional antennas 3 by adhesion.

The energy storage apparatus 4 is located in the housing 1, is electrically connected to the thermoelectric conditioning circuit and the RF-DC conditioning circuit, and is configured to store electrical energy. The energy storage apparatus 4 may be distributed on a bottom of an inner side of the housing 1, and is responsible for storing electrical energy converted from RF energy and thermal energy. When required, the energy storage apparatus 4 may be connected to a load to provide a stable supply of electrical energy. The energy storage apparatus 4 may be a storage battery.

The hybrid energy harvesting apparatus further includes a circuit board 6 arranged in the housing 1 and temperature sensors and current sensors which are mounted on the thermoelectric sheets 2 and the multi-band two-dimensional antennas 3. The circuit board 6 includes a rectification circuit, a filtering circuit, a conversion circuit, a control chip, etc. The thermoelectric conditioning circuit and the RF-DC conditioning circuit are both formed by the rectification circuit, the filtering circuit, and the conversion circuit. The circuit board 6 is related to energy harvesting, and may be distributed around the energy storage apparatus 4 in the housing 1. The temperature sensors and the current sensors are in signal connection with the control chip, so that the energy storage apparatus 4 may further be configured to further process the electrical energy obtained through conversion by sensors in the RF harvesting apparatus and the thermoelectric harvesting apparatus, monitor parameters such as temperature and current in the RF harvesting apparatus and the thermoelectric harvesting apparatus, and adjust an operational state as required to achieve an optimal energy harvesting effect.

The housing 1 of the hybrid energy harvesting apparatus is a hollow polyhedron. The thermoelectric sheets 2 and the multi-band two-dimensional antenna arrays are stacked in sequence on the outer side surface of the housing 1. The thermoelectric conditioning circuit, the RF-DC conditioning circuit, and the energy storage apparatus are mounted in the housing. The thermoelectric sheets 2 are sandwiched between the housing 1 and the multi-band two-dimensional antennas. The cold end of each of the thermoelectric sheets 2 is tightly attached to the corresponding multi-band two-dimensional antenna array. The multi-band two-dimensional antennas 3 harvest omnidirectional multi-band RF energy and convert the harvested RF energy to electrical energy. The RF-DC conditioning circuit conditions the electrical energy generated by the multi-band two-dimensional antennas 3. In addition, the multi-band two-dimensional antennas 3 serve as a heat sink for the corresponding thermoelectric sheets, to cool down the cold end of each the thermoelectric sheets 2 to form a required temperature difference between the hot end and the cold end of the thermoelectric sheet 2. As such, the thermoelectric sheets 2 fully capture thermal energy in the natural environment and the system, so that a voltage is generated on the surface of the thermoelectric material to form electrical energy, which is subjected to processing such as rectification, filtering, and AC-DC conversion by the thermoelectric conditioning circuit. The energy storage apparatus 4 stores the electrical energy that has been processed by the thermoelectric conditioning circuit and the RF-DC conditioning circuit, and provides the electrical energy to a load for use. Harvesting of omnidirectional multi-band RF energy and thermal energy is realized through the polyhedral housing 1, the thermoelectric sheets 2, and the multi-band two-dimensional antenna arrays. With the use of the multi-band technology, the hybrid energy harvesting apparatus can adapt to changes in the intensity and frequency of RF energy in different environments and working scenarios, and can capture more RF energy and convert the RF energy to electrical energy, thereby improving the energy harvesting efficiency.

The multi-band two-dimensional antenna arrays of the hybrid energy harvesting apparatus realize harvesting of omnidirectional multi-band RF energy. The proportion of RF energy in the space of a natural environment is low, and unidirectional RF harvesting cannot meet requirements on the energy harvesting efficiency of a self-powered apparatus in future Internet of Things applications. The hybrid energy harvesting apparatus uses a cubic housing 1, and the thermoelectric sheets 2 and the multi-band two-dimensional antenna arrays are arranged on a top surface and side surfaces of the cubic housing 1, i.e., the thermoelectric sheets 2 and the multi-band two-dimensional antenna arrays are arranged on five sides of the housing 1. As such, a multi-directional RF energy harvesting technology is realized. Antennas in multiple directions enable the hybrid energy harvesting apparatus to harvest energy even in an environment with scarce RF energy, thereby achieving high adaptability and stability.

The thermoelectric sheets 2 of the hybrid energy harvesting apparatus have a characteristic of broadly harvesting thermal energy in a system. Because the thermoelectric sheets 2 are tightly attached to the outer side surface of the housing 1, the thermoelectric sheets 2 can capture thermal energy inside the housing 1 to the greatest extent, to achieve efficient energy conversion. Therefore, the hybrid energy harvesting apparatus has excellent thermal energy harvesting performance, can adapt to various environmental conditions, and has high reliability and stability.

The hybrid energy harvesting apparatus makes full use of the structural similarity between the antenna structure and a heat-dissipating metal plate, and the multi-band two-dimensional antenna arrays are tightly attached to the surfaces of the corresponding thermoelectric sheets 2, so that the multi-band two-dimensional antenna arrays are combined with the thermoelectric sheets 2, to realize conversion between RF energy and thermoelectric energy. By using such a structure, the energy harvesting efficiency can be significantly improved, and the spatial layout is optimized, thereby achieving miniaturization. The multi-band two-dimensional antenna arrays also serve as heat-dissipating metal plates, and thermal energy generated by the hybrid energy harvesting apparatus and thermal energy in the surrounding environment are converted to electrical energy by the thermoelectric sheets 2, so that not only the energy conversion process is optimized, but also the conversion between the two types of energy is facilitated, thereby achieving higher energy harvesting efficiency. In addition, the multi-band two-dimensional antennas 3 also serve as a heat dissipation structure for the corresponding thermoelectric sheets, thereby saving space, facilitating miniaturization, and providing new ideas and possibilities for further development and application of hybrid energy harvesting systems for harvesting RF energy and thermoelectric energy.

The hybrid energy harvesting apparatus is of a compact design and a skillful structure, is convenient to operate and implement, has a wide application range, is applicable to various environments and scenarios, and exhibits excellent energy harvesting efficiency both indoors and outdoors. The hybrid energy harvesting apparatus may be used as a power supply device for nodes in a future Internet of Things environment, to provide a stable energy supply to various devices, showing broad application prospects and huge development potential.

Apparently, those skilled in the art may make various modifications and variations to the embodiments of the present disclosure without departing from the spirit and scope of the present disclosure. Such modifications and variations shall be construed as falling with the scope of the present disclosure as long as they do not depart from the scope of the claims of the present disclosure and their equivalents.

1. A hybrid energy harvesting apparatus for harvesting omnidirectional multi-band radio frequency (RF) energy and thermoelectric energy, comprising a housing, an RF harvesting apparatus, a thermoelectric harvesting apparatus, and an energy storage apparatus, wherein
the housing is a hollow polyhedron;
the thermoelectric harvesting apparatus comprises a thermoelectric sheet applied to an outer side surface of the housing and a thermoelectric conditioning circuit mounted in the housing; a hot end of the thermoelectric sheet is connected to the housing and is configured to connect to a heat source, and a cold end of the thermoelectric sheet is located on a side of the thermoelectric sheet facing away from the housing; the thermoelectric sheet is configured to harvest thermal energy from an environment and the heat source and convert the thermal energy to first electrical energy; the thermoelectric conditioning circuit is electrically connected to the thermoelectric sheet, and the thermoelectric conditioning circuit is configured to condition the first electrical energy generated by the thermoelectric sheet;
the RF harvesting apparatus comprises a multi-band two-dimensional antenna array tightly attached to the thermoelectric sheet and an RF-direct current (DC) conditioning circuit mounted in the housing; a multi-band two-dimensional antenna in the multi-band two-dimensional antenna array is configured to harvest the omnidirectional multi-band RF energy and convert the omnidirectional multi-band RF energy to second electrical energy, and dissipate heat from the thermoelectric sheet; the RF-DC conditioning circuit is connected to the multi-band two-dimensional antenna, and the RF-DC conditioning circuit is configured to condition the second electrical energy generated by the multi-band two-dimensional antenna; and
the energy storage apparatus is located in the housing, is electrically connected to the thermoelectric conditioning circuit and the RF-DC conditioning circuit, and is configured to store the first electrical energy and the second electrical energy.

2. The hybrid energy harvesting apparatus according to claim 1, wherein the multi-band two-dimensional antenna is formed by a plurality of different cuboid sheets.

3. The hybrid energy harvesting apparatus according to claim 2, wherein the multi-band two-dimensional antenna is formed by three types of cuboid sheets with different lengths and widths.

4. The hybrid energy harvesting apparatus according to claim 1, further comprising a circuit board arranged in the housing, wherein
the circuit board comprises a rectification circuit, a filtering circuit, a conversion circuit, and a control chip; and
the thermoelectric conditioning circuit and the RF-DC conditioning circuit are both formed by the rectification circuit, the filtering circuit, and the conversion circuit.

5. The hybrid energy harvesting apparatus according to claim 4, further comprising temperature sensors and current sensors, wherein the temperature sensors and the current sensors are mounted on the thermoelectric sheet and the multi-band two-dimensional antenna; and
the temperature sensors and the current sensors are in signal connection with the control chip.

6. The hybrid energy harvesting apparatus according to claim 1, wherein the housing is of a cubic structure, and the thermoelectric sheet is attached to a top surface and a side surface of the housing.

7. The hybrid energy harvesting apparatus according to claim 1, wherein the housing is made of an insulating material.

8. The hybrid energy harvesting apparatus according to claim 1, wherein the thermoelectric sheet is connected to the housing and the multi-band two-dimensional antenna by adhesion.

9. The hybrid energy harvesting apparatus according to claim 1, wherein the energy storage apparatus is a storage battery.

10. The hybrid energy harvesting apparatus according to claim 2, wherein the thermoelectric sheet is connected to the housing and the multi-band two-dimensional antenna by adhesion.

11. The hybrid energy harvesting apparatus according to claim 3, wherein the thermoelectric sheet is connected to the housing and the multi-band two-dimensional antenna by adhesion.

12. The hybrid energy harvesting apparatus according to claim 4, wherein the thermoelectric sheet is connected to the housing and the multi-band two-dimensional antenna by adhesion.

13. The hybrid energy harvesting apparatus according to claim 5, wherein the thermoelectric sheet is connected to the housing and the multi-band two-dimensional antenna by adhesion.

14. The hybrid energy harvesting apparatus according to claim 6, wherein the thermoelectric sheet is connected to the housing and the multi-band two-dimensional antenna by adhesion.

15. The hybrid energy harvesting apparatus according to claim 7, wherein the thermoelectric sheet is connected to the housing and the multi-band two-dimensional antenna by adhesion.

16. The hybrid energy harvesting apparatus according to claim 2, wherein the energy storage apparatus is a storage battery.

17. The hybrid energy harvesting apparatus according to claim 3, wherein the energy storage apparatus is a storage battery.

18. The hybrid energy harvesting apparatus according to claim 4, wherein the energy storage apparatus is a storage battery.

19. The hybrid energy harvesting apparatus according to claim 5, wherein the energy storage apparatus is a storage battery.

20. The hybrid energy harvesting apparatus according to claim 6, wherein the energy storage apparatus is a storage battery.
